(19) United States
(12) Patent Application Publication
(10) Pub. No.: US 2010/0146592 A1
(43) Pub. Date: Jun. 10, 2010

(54) SYSTEMS AND METHODS FOR PROVIDING SESSION CONTINUITY ACROSS A CHASSIS MANAGEMENT CONTROLLER FAILOVER

(75) Inventors: Kalyani Gamare, Austin, TX (US); Michael Jon Roberts, Austin, TX (US); Ashish Munjal, Round Rock, TX (US)

Correspondence Address: Baker Botts L.L.P, 910 Louisiana Street, One Shell Plaza, HOUSTON, TX, 77002, US

(73) Assignee: DELL PRODUCTS L. P., Round Rock, TX (US)

(21) Appl. No.: 12/328,452

(22) Filed: Dec. 4, 2008

(51) Int. Cl. G06F 21/20

(52) U.S. Cl. 726/4

(57) ABSTRACT

A method for maintaining a continuous authenticated session in an information handling system including first and second chassis management controllers (CMCs) is provided. The first CMC receives user authentication information from a user, authenticates the user for a communication session based on the received user authentication information, generates session information regarding the communication session based at least on the received user authentication information, and stores the session information in memory accessible to the second CMC. Upon a failover from the first CMC to the second CMC, the second CMC automatically accesses the session information from the memory and uses the accessed session information to continue the communication session.

### TECHNICAL FIELD

The present disclosure relates in general to information handling systems, and more particularly to systems and methods for providing session continuity across a chassis management controller (CMC) failover.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a blade server, or simply “blade.” Blades are often self-contained information handling systems designed specifically to allow the placement of multiple blades in a single enclosure or aggregation of enclosures. A blade enclosure or chassis may hold multiple blades and provide services to the various blades such as power, cooling, networking, interconnects, and management.

A blade enclosure or chassis may include one or more chassis management controllers (CMCs) configured to provide local and/or remote management of various chassis functions. Some blade server chasses include redundant CMCs such when an active CMC fails, the system may automatically fail over to a standby CMC, which then becomes the active CMC.

Typically, when an active CMC fails over to a standby CMC, any currently active authenticated user sessions with the server are terminated and the user must re-authenticate (e.g., re-enter a username and password) in order to continue the session. This is not ideal for applications or systems that require or desire continuous sessions, e.g., stock exchange systems, high-security systems, air traffic control systems, etc.

### SUMMARY

In accordance with the teachings of the present disclosure, certain disadvantages and problems associated with providing continuous communication sessions, including after a failover from an active CMC to a standby CMC, have been substantially reduced or eliminated.

According to certain embodiments of the present disclosure, a method for maintaining a continuous authenticated session in an information handling system including at least first and second chassis management controller (CMCs) is provided. The first CMC receives user authentication information from a user, authenticates the user for a communication session based on the received user authentication information, generates session information regarding the communication session based at least on the received user authentication information, and stores the session information in memory accessible to the second CMC. Upon a failover from the first CMC to the second CMC, the second CMC automatically accesses the session information from the memory and uses the accessed session information to continue the communication session.

According to certain embodiments of the present disclosure, an information handling system includes a first chassis management controller (CMC), a second CMC, and memory accessible to both the first and second CMCs. The first CMC is configured to: receive user authentication information from a user; authenticate the user for a communication session based on the received user authentication information; generate session information regarding the communication session based at least on the received user authentication information; and cause the session information to be stored in the memory. The second CMC is configured to: automatically access the session information from the memory in response to a failover from the first CMC to the second CMC; and use the accessed session information to continue the communication session.

According to certain embodiments of the present disclosure, logic instructions for maintaining a continuous authenticated session in an information handling system including at least first and second chassis management controllers (CMCs). The logic instructions are embodied in tangible computer readable media and are executable by a processor. The logic instructions include: instructions for receiving user authentication information from a user; instructions for authenticating the user for a communication session based on the received user authentication information; instructions for generating session information regarding the communication session based at least on the received user authentication information; and instructions for storing the session information in memory accessible to the second CMC such that upon a failover from the first CMC to the second CMC, the second CMC can automatically access the session information from the memory and use the accessed session information to continue the communication session without requiring re-authentication by the user.

### BRIEF DESCRIPTION OF THE DRAWINGS

A more complete understanding of the disclosed embodiments and advantages thereof may be acquired by referring, by way of example, to the following description taken in conjunction with the accompanying drawings, in which like reference numbers indicate like features, and wherein:

FIG. 1 illustrates an example embodiment of an information handling system configured to provide session continuity across CMC failover, in accordance with certain embodiments of the present disclosure;

FIG. 2 illustrates an example CMC configured to generate and store session information in shared storage, according to certain embodiments of the present disclosure;

FIG. 3 illustrates an example data flow of session information between an active CMC and a standby CMC within a blade server chassis, according to certain embodiments;

FIG. 4 illustrates an example data flow of session information through firmware stacks of an active CMC and a standby CMC within a blade server chassis, according to certain embodiments; and

FIG. 5 illustrates and example method for maintaining session continuity across a CMC failover, according to certain embodiments of the present disclosure.

### DETAILED DESCRIPTION

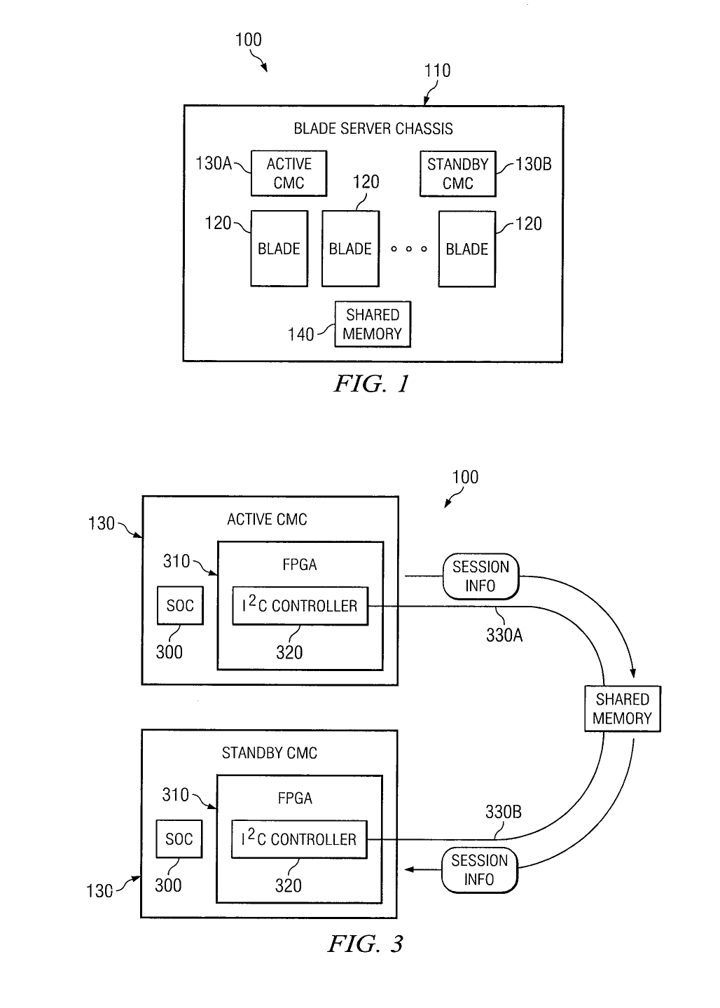

Preferred embodiments and their advantages are best understood by reference to FIGS. 1-5.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates an example embodiment of an information handling system 100 configured to provide session continuity across CMC failover, in accordance with certain embodiments of the present disclosure. In this example, information handling system 100 is a blade server chassis 100 including a housing 110, multiple blades 120, a first chassis management controller (CMC) 130A, a second CMC 130B, a memory device 140, and/or any other suitable information handling system components (e.g., fan modules, I/O modules, etc.). It should be understood that although a blade server chassis 100 is illustrated, the concepts disclosed herein may be applied to any other type of information handling system including redundant CMCs.

Blades 120 may be arranged in any suitable manner within housing 110. For example, blades 120 may be arranged in rows and/or stacks.

Each CMC 130 may provide various management functions for blade server chassis 100. For example, each CMC 130 may provide any of the following functions such as remote management capabilities, power management functions (e.g., monitoring and controlling power supply units (PSUs)), I/O module management, blade management, thermal management (e.g., fan control), Intelligent Platform Management Interface (IPMI), link tuning management, KVM management, monitoring system components, providing access to system information and status of components, providing access to . . . . More a hardware log and CMC log, voltage level control, monitoring of on/off power sequence, monitoring of system resets, etc.

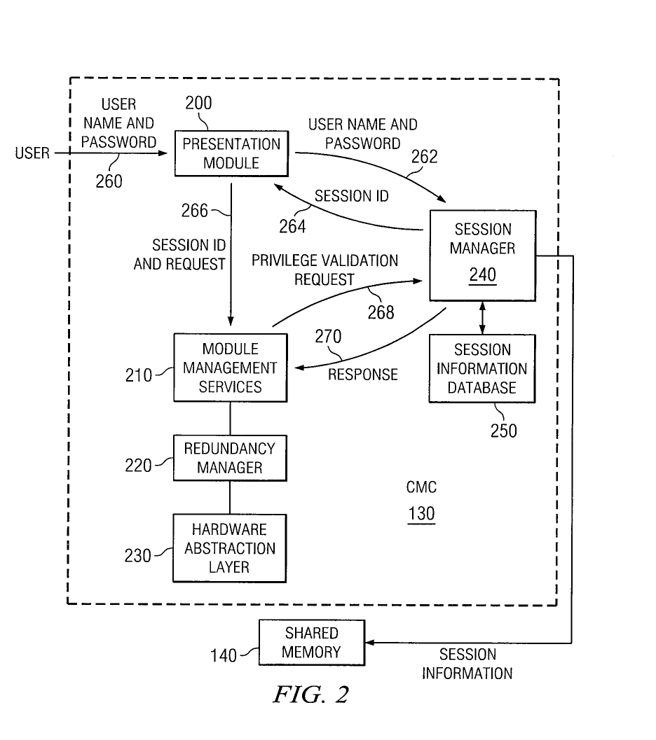

Each CMC 130 may include, or have access to, any suitable hardware, software, and/or firmware for providing any of the functionality discussed herein. For example, CMC 130 may include, or have access to a processor and logic instructions (e.g., software and/or firmware) encoded in computer readable media and executable by the processor to provide any of the functionality discussed herein. An example CMC 130 is shown and discussed in more detail below with reference to FIG. 2.

In operation, at any given time, one of CMC 130A and CMC 130B acts as the active CMC and the other acts as a standby CMC ready to take over (i.e., become the active CMC) if the active CMC fails.

With respect to a particular communication session for a particular user, the currently active CMC 130 may be configured to: (a) receive user authentication information (e.g., a username and password) from the particular user attempting to initiate a communication session with system 100, (b) authenticate the particular user for the communication session based on the user authentication information received from the particular user; (c) generate session information regarding the communication session based at least on the received user authentication information; and (d) store the session information in memory device 140 accessible to both CMCs 130.

Upon a failover event that causes a failover from the active CMC 130 to the standby CMC 130, the standby CMC 130 may automatically access the session information from memory device 140, and use the accessed session information to automatically and seamlessly continue the communication session without requiring re-authentication from the particular user.

CMCs 130 may provide such functionality for each active session on system 100 involving various users, such that each active session may be continued despite a CMC failover, without requiring users to re-authenticate their sessions.

As used herein, the term “session information” refers to any information regarding a communication session of a user that may be managed by a CMC 130 and/or stored in memory device 140. For example, for a particular session of a particular user, session information may include any or all of the following:
Authentication information regarding the particular user (e.g., username and password);
User privilege data regarding the particular user (e.g., defining privileges assigned to the particular user for performing various actions or accessing various data);
Session type data identifying the session type of the particular session (e.g., a web-based GUI session, a telnet session, a secure shell protocol (SSH) session, a serial link session, a remote CLI session, etc.);
Session timeout data defining a time period for a session to time out (e.g., after a period of inaction by the particular user). The session timeout data may depend on the particular session type;
A session ID, which may be a unique ID used across subsystems in CMC 130 (e.g., across subsystems within CMC firmware). The session ID may be automatically generated (e.g., by session manager 240, discussed below with reference to FIG. 2) when the particular user locally or remotely connects to CMC 130 (e.g., enters a valid username and password). In some embodiments, the session ID may be valid until a session expires.

In some embodiments, the session ID may be linked to session attribute data (e.g., user privilege data, session type data, and/or session timeout data) and stored in a look-up table or other database.

Memory device 140 may comprise any suitable computer-readable medium configured to store session information associated with one or more communication sessions related to system 100. Memory device 140 may be accessible to both CMC 130A and CMC 130B. In some embodiments, memory device 140 may comprise a persistent storage medium. For example, memory device 140 may comprise a chassis EEPROM in a local control front panel LCD of blade server chassis 100.

FIG. 2 illustrates an example CMC 130 (e.g., CMC 130A or CMC 130B) configured to generate and store session information in shared storage 140, according to certain embodiments of the present disclosure. CMC 130 may include a presentation module 200, one or more module management services 210, a redundancy manager 220, a hardware abstraction layer (HAL) 230, a session manager 240, and a session information database 250.

Presentation module 200 may provide a user interface for users attempting to access CMC 130. Presentation module 200 may support various user session types via different communication type or protocols, e.g., web-based GUI sessions, telnet sessions, secure shell protocol (SSH) sessions, serial link sessions, remote CLI sessions, etc.

Presentation module 200 may provide an interface allowing a user to enter user authentication data (e.g., a username and password) and a user request (e.g., a server power-on request).

Module management services 210 may include any management services provided by CMC 130, including power management, I/O module management, blade management, thermal management, link tuning management, KVM management, Intelligent Platform Management Interface (IPMI), etc.

Redundancy manager 220 may be configured to manage CMC failovers, e.g., upon a failure event. Redundancy manager 220 may comprise a software module.

Session manager 240 may be configured to authenticate users, generate and store session information, and communicate particular session information with other components of CMC 130 (e.g., presentation module 200 and module management services 210). For example, generate and store session information in session information database 250.

In addition, session manager 240 may be configured to communicate session information to shared storage such that the standby CMC 130 may automatically access the session information upon a failover to the standby CMC 130. For example, if CMC 130A is the active CMC, CMC 130A may save the session information in memory device 140 accessible by both CMC 130A and CMC 130B such that if CMC 130A fails over to CMC 130B, CMC 130B can automatically access the session information and continue any active sessions without requiring the users to re-login or re-authenticate. In some embodiments, session manager 240 may be configured to encrypt and/or decrypt session information, such that session information may be stored in session information database 250 and/or memory device 140 as encrypted data.

Session information database 250 may comprise any suitable computer-readable medium for storing one or more look-up tables or other databases of session information, some or all of which may also be stored in shared memory device 140. Session information database 250 may also include valid authentication information (e.g., usernames and passwords) corresponding to authenticated users of a network, which valid authentication information may be accessed by session manager 240 for making user authentication determinations.

In operation, a user may attempt to connect to an active CMC, say CMC 130B, by interfacing with presentation module 200 of CMC 130B. Presentation module 200 may present the user with a login screen asking the user for a username and password. Once the user enters a username and password, as indicated at 260, presentation module 200 may forward the username and password to session manager 240, as indicated at 262. Session manager 240 may access valid authentication information from session information database 250 and determine whether the user is an authenticated user. If session manager 240 determines that the user is not an authenticated user, session manager 240 notify presentation module 200, which may request the user to enter a new username and/or password. Alternatively, if session manager 240 determines that the user is an authenticated user, session manager 240 may authenticate the session and generate a session ID and other session information for the session.

For example, when session manager 240 receives user authentication information (e.g., username and password) from presentation module 200 for a user attempting to initiate a session, session manager 240 may access data in session information database 250 linking various users to user authentication information in order to identify the user. Session manager 240 may further access data in session information database 250 linking various users to user privilege data in order to identify privilege data associated with the identified user. Session manager 240 may include at least a portion of such information identified for the user in the session information for the requested session.

As another example, when session manager 240 receives user authentication information (e.g., username and password) from presentation module 200 for a user attempting to initiate a session, session manager 240 may access data in session information database 250 linking various user authentication information for various users to user privilege data for such various users, and identify user privilege data corresponding to the received user authentication information. Session manager 240 may include at least a portion of the identified user privilege data in the session information for the requested session.

As another example, presentation module 200 and/or session manager 240 may determine a session type for the requested session (e.g., a web-based GUI session, a telnet session, a secure shell protocol (SSH) session, a serial link session, a remote CLI session, etc.). Session manager 240 may include the session type in the session information for the requested session.

After authenticating the user and generating other session information, session manager 240 may communicate the session ID to presentation module 200, as indicated at 264. When the user makes a request during the session (e.g., a request to power on a server), presentation module 200 may send the session ID for the session, along with the requested action, to one or more appropriate module management services 210, as indicated at 266. In some instances, before performing the requested action, the appropriate module management service(s) 210 may communicate with session manager 240 to determine whether the user has the appropriate privileges to perform the requested action. For example, the appropriate module management service(s) 210 may send the session ID and a privilege validation request for the requested action, as indicated at 268. Session manager 240 may access session information database 250 to determine whether the privilege data linked to the session ID indicates that the user is allowed to perform the requested action. Session manager 240 may then respond to the privilege validation request, as indicated at 270. If the response indicates that the user is allowed to perform the requested action, module management service(s) 210 may then perform the requested action. If not, module management service(s) 210 and/or presentation module 200 may notify the user that the user is not allowed to perform the requested action.

FIG. 3 illustrates an example data flow of session information between an active CMC 130 and a standby CMC 130 within a blade server chassis 100, according to certain embodiments. Blade server chassis 100 may include an active CMC 130, a standby CMC 130, and a shared memory 140. In this embodiment, shared memory 140 is a chassis EEPROM.

Each CMC 130 may include a system-on-a-chip (SOC) 300 and a field programmable gate array (FPGA) 310 including an I²C controller 320. Each CMC 130 may be connected to chassis EEPROM 140 by an I²C bus 330. Thus, communications between SOC 300 of either CMC 130 and chassis EEPROM 140 may be driven by an I²C controller 320. The two CMCs 130 may share a common encryption key, which may be stored, e.g., in each SOC 300.

In operation, after generating session information for a particular user session (e.g., as discussed above), the active CMC 130 may encrypt the session information using the shared encryption key, and communicate the encrypted session information via I²C bus 330A to chassis EEPROM 140 for storage. During or after a failover from the active CMC 130 to the standby CMC 130, the standby CMC 130 may access the encrypted session information from chassis EEPROM 140 via I²C bus 330B, decrypt the session information using the shared encryption key, and use the session information to continue the session without requiring re-authentication from the user.

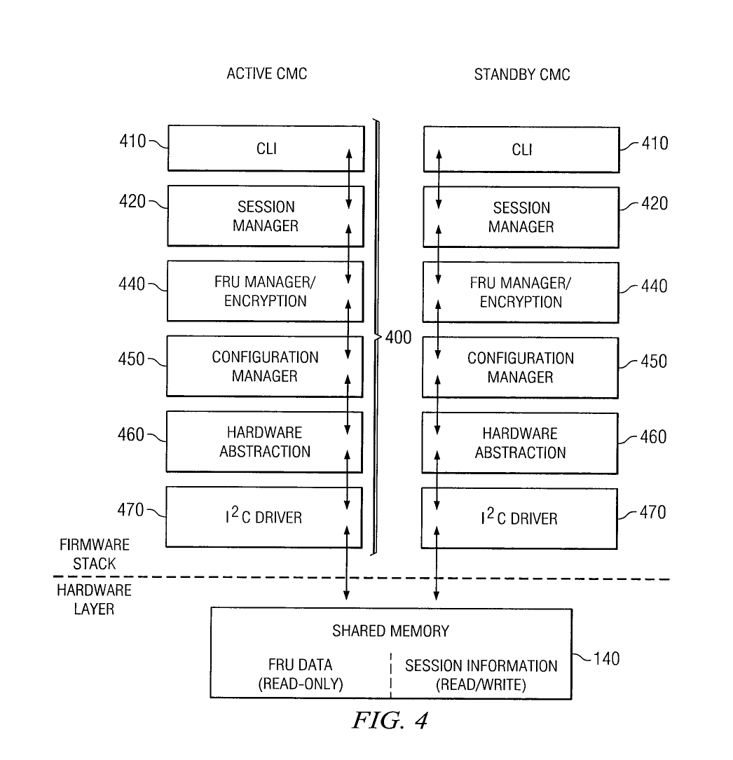

FIG. 4 illustrates an example data flow of session information through firmware stacks of an active CMC 130 and a standby CMC 130 within a blade server chassis 100, according to certain embodiments. Blade server chassis 100 may include an active CMC 130, a standby CMC 130, and a shared memory 140. In this embodiment, shared memory 140 is a chassis EEPROM.

Each CMC 130 may include a firmware stack 400 including a command line interface (CLI) 410, a session manager 420 (e.g., session manager 240 discussed above), an FRU manager/encryption layer 440, a configuration manager layer 450, a hardware abstraction layer 460, and an I²C controller device driver 470.

In some embodiments, shared memory device 140 (e.g., EEPROM) is divided into a read-only portion, e.g., for storing FRU data, and a read-write portion, e.g., for storing session information. In such embodiments, FRU manager/encryption layer 440 may be configured to ensure that session information is written only to the read-write portion of memory device 140 and thus kept segregated from FRU data in the read-only portion of memory device 140.

Configuration manager layer 450 may maintain a database of configurable properties, may validate the format of session information to be stored in memory device 140, and/or may validate the read-only vs. read-write segregation of data in memory device 140.

Hardware abstraction layer 460 may abstract hardware details from the software layers to allow the software to be implemented in any suitable hardware.

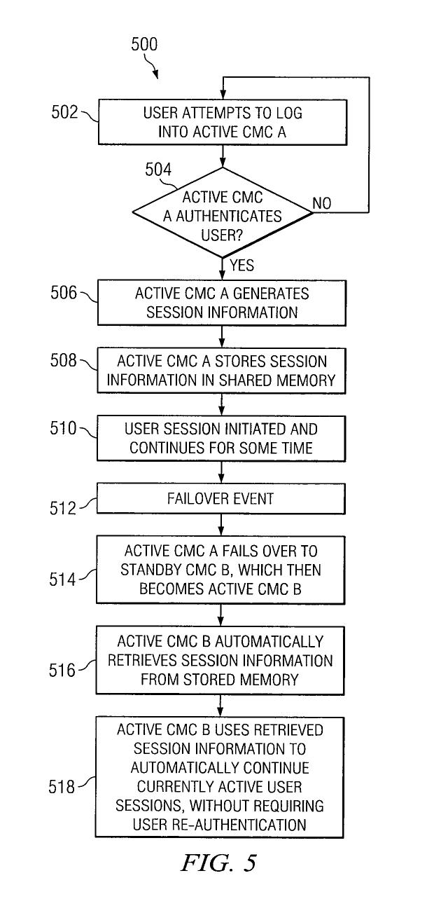

FIG. 5 illustrates and example method 500 for maintaining session continuity across a CMC failover, according to certain embodiments of the present disclosure. The method may be implemented in a system including redundant CMCs 130A and 130B, and a shared memory device 140, wherein a first CMC 130A is currently active and a second CMC 130B is in standby mode.

At step 502, a user A attempts to log into active CMC 130A to initiate a communication session by entering a username and a password. At step 504, active CMC 130A determines whether to authenticate user A based on the username and password. If active CMC 130A determines not to authenticate user A, the method may return to step 502. If active CMC 130A determines to authenticate user A, the method may advance to step 506.

At step 506, active CMC 130A generates session information, for example, a session ID and corresponding session attributes (e.g., user privilege data and session type data). At step 508, active CMC 130A stores the session information in shared memory device 140. At step 510, the session may be initiated and continue for some time, during which user A may perform any various action as desired.

At step 512, a failover event occurs. Example failover events may include: (a) a user-initiated switchover from active CMC 130A to standby CMC 130B (e.g., initiated via CLI or GUI); (b) active CMC 130A taking exception, and hanging; (c) active CMC 130A taking exception, and resetting; (d) active CMC 130A is physically removed (e.g., suddenly pulled out of the chassis); or (e) a Watchdog Timer of active CMC 130A resets the active CMC 130A board.

At step 514, in response to the failover event, active CMC 130A fails over to standby CMC 130B such that standby CMC 130B becomes the active CMC. This may occur in various manners. For example, during the failover event, the redundancy manager 220 (see FIG. 2) of active CMC 130A may notify the redundancy manager 220 of standby CMC 130B of the failover event, such that redundancy manager 220 of standby CMC 130B may switch standby CMC 130B from standby to active status. As another example, the redundancy manager 220 of standby CMC 130B may identify that active CMC 130A has stopped responding to a regular heartbeat signal (e.g., a peer daemon), and in response, switch standby CMC 130B from standby to active status.

At step 516, in response to the failover from the CMC 130A to CMC 130B, session manager 240 of the now-active CMC 130B may automatically retrieve session information from stored memory device 140 for all active sessions, including user A's session. At step 518, session manager 240 of CMC 130B may automatically use the session information retrieved from stored memory device 140 to continue each currently active session, without requiring re-authentication from the relevant users.

In this manner, user A's session (along with each other active session) may be continued across the failover from CMC 130A to CMC 130B, without requiring re-authentication of the session by user A.

Although the present disclosure has been described in detail, it should be understood that various changes, substitutions, and alterations can be made hereto without departing from the spirit and the scope of the disclosure as defined by the appended claims.

What is claimed is:

1. A method for maintaining a continuous authenticated session in an information handling system including at least a first chassis management controllers (CMC) and a second CMC, the method comprising:
a first CMC receiving user authentication information from a user;
the first CMC authenticating the user for a communication session based on the received user authentication information;
the first CMC generating session information regarding the communication session based at least on the received user authentication information;
the first CMC storing the session information in memory accessible to the second CMC;
in response to a failover from the first CMC to the second CMC, the second CMC automatically accessing the session information from the memory; and
the second CMC using the accessed session information to continue the communication session.

2. A method according to claim 1, wherein the second CMC uses the accessed session information to continue the communication session without requiring re-authentication by the user.

3. A method according to claim 1, wherein the received user authentication information includes a username and a password.

4. A method according to claim 1, wherein generating session information regarding the communication session includes:
identifying the user based on the received user authentication information; and
automatically accessing privilege data associated with the identified user;
wherein the session information includes at least a portion of the user authentication information and at least a portion of the accessed privilege data.

5. A method according to claim 1, wherein generating session information regarding the communication session includes:
accessing a database corresponding user privilege data with user authentication information for each of multiple users;
identifying from the database user privilege data corresponding to the user authentication information received from the user; and
including at least a portion of the identified user privilege data in the session information.

6. A method according to claim 1, wherein generating session information includes:
determining a session type based at least on a type of communication link by which the user is connected to the first CMC; and
identifying the session type in the session information.

7. A method according to claim 1, wherein:
the first and second CMCs are located in a blade server chassis; and
the first CMC stores the session information in a persistent storage device shared by the first the second CMCs.

8. A method according to claim 7, wherein the persistent storage device comprises a chassis EEPROM in a local control front panel of the blade server chassis.

9. An information handling system, comprising:
a first chassis management controller (CMC);
a second CMC; and
memory accessible to both the first and second CMCs;
the first CMC being configured to:
receive user authentication information from a user;
authenticate the user for a communication session based on the received user authentication information;
generate session information regarding the communication session based at least on the received user authentication information; and
cause the session information to be stored in the memory; and
the second CMC being configured to:
automatically access the session information from the memory in response to a failover from the first CMC to the second CMC; and
use the accessed session information to continue the communication session.

10. An information handling system according to claim 9, wherein the second CMC uses the accessed session information to continue the communication session without requiring re-authentication by the user.

11. An information handling system according to claim 9, wherein generating session information regarding the communication session includes:
identifying the user based on the received user authentication information; and
automatically accessing privilege data associated with the identified user;
wherein the session information includes at least a portion of the user authentication information and at least a portion of the accessed privilege data.

12. An information handling system according to claim 9, wherein generating session information regarding the communication session includes:
accessing a database corresponding user privilege data with user authentication information for each of multiple users;
identifying from the database user privilege data corresponding to the user authentication information received from the user; and
including at least a portion of the identified user privilege data in the session information.

13. An information handling system according to claim 9, wherein generating session information includes:
determining a session type based at least on a type of communication link by which the user is connected to the first CMC; and
identifying the session type in the session information.

14. An information handling system according to claim 9, further comprising a blade server chassis configured to house the first CMC, the second CMC, and the memory;
wherein the memory comprises a persistent storage device shared by the first the second CMCs.

15. An information handling system according to claim 14, wherein the persistent storage device comprises a chassis EEPROM in a local control front panel of the blade server chassis.

16. Logic instructions for maintaining a continuous authenticated session in an information handling system including at least a first chassis management controllers (CMC) and a second CMC, the logic instructions embodied in tangible computer readable media and executable by a processor, comprising:
instructions for receiving user authentication information from a user;
instructions for authenticating the user for a communication session based on the received user authentication information;
instructions for generating session information regarding the communication session based at least on the received user authentication information;
instructions for storing the session information in memory accessible to the second CMC such that upon a failover from the first CMC to the second CMC, the second CMC can automatically access the session information from the memory and use the accessed session information to continue the communication session without requiring re-authentication by the user.

17. Logic instructions according to claim 16, wherein instructions for generating session information regarding the communication session include:
instructions for identifying the user based on the received user authentication information; and
instructions for accessing privilege data associated with the identified user;
instructions for including at least a portion of the user authentication information and at least a portion of the accessed privilege data in the session information.

18. Logic instructions according to claim 16, wherein instructions for generating session information regarding the communication session include:
instructions for accessing a database corresponding user privilege data with user authentication information for each of multiple users;
instructions for identifying from the database user privilege data corresponding to the user authentication information received from the user; and
instructions for including at least a portion of the identified user privilege data in the session information.

19. Logic instructions according to claim 16, wherein instructions for generating session information regarding the communication session include:
instructions for determining a session type based at least on a type of communication link by which the user is connected to the first CMC; and
instructions for identifying the session type in the session information.

20. Logic instructions according to claim 16, wherein instructions for storing the session information in memory accessible to the second CMC include instructions for storing the session information in a persistent storage device in a local control front panel of a blade server chassis that includes the first and second CMCs.
